(19) United States
(12) Patent Application Publication
(10) Pub. No.: US 2013/0033240 A1
(43) Pub. Date: Feb. 7, 2013

(54) PFC THD REDUCTION BY ZVS OR VALLEY SWITCHING

(71) Applicant: Zhong J. Ye, Plano, TX (US)

(72) Inventor: Zhong J. Ye, Plano, TX (US)

(73) Assignee: Texas Instruments Incorporated, Dallas, TX (US)

(21) Appl. No.: 13/531,223

(22) Filed: Jun. 22, 2012

Related U.S. Application Data
(60) Provisional application No. 61/502,544, filed on Jun. 29, 2011.

(51) Int. Cl. G05F 1/70

(52) U.S. Cl. 323/211

(57) ABSTRACT

A digital controller for a power factor correction (PFC) circuit, has first means for generating a first control signal for a switching transistor to avoid continuous oscillation between an inductor and parasitic capacitance of the switching transistor during discontinuous mode operation when an input voltage is less than substantially 50% of an output voltage. Second means generates a second control signal for a switching transistor to avoid continuous oscillation between an inductor and parasitic capacitance of the switching transistor during discontinuous mode operation when an input voltage is greater than substantially 50% of an output voltage. A power factor correction circuit and a method of operating a power factor correction circuit are also disclosed.

### CROSS-REFERENCE TO RELATED APPLICATIONS

This patent application claims priority from U.S. Provisional Application No. 61/502,544, filed Jun. 29, 2011, which is incorporated herein by reference in its entirety.

### FIELD OF THE INVENTION

The invention relates generally to a PFC correction circuit and more specifically to a boost PFC circuit.

### BACKGROUND OF THE INVENTION

Reactive loads on an electric power system draw higher current than a load which is more resistive and has a higher power factor. The energy stored in the load and returned to the source or nonlinear load currents distort the shape of the current drawn from the source requiring higher currents to drive the load. These higher currents increase the amount of energy lost in the distribution system. To recover the costs of the larger equipment required, utilities may charge a higher cost for low-power factor loads.

PFC correction circuits are utilized for making a reactive load on an AC line appear to be resistive. Power factor has a range of 0 to 1, with 1 being purely resistive. In order to achieve a high power factor, the phase angle of the input current must closely match the phase angle of the input voltage. Thus, the purpose of a PFC correction circuit is to alter the phase angle of the input current in order to closely match that of the input voltage. If the phase angle of both currents and voltages are perfectly matched, the power factor will be 1.

A common type of power factor correction circuit is a boost power factor correction circuit. In a boost power factor correction circuit, the output voltage is higher than the input voltage. FIG. 1 shows a common form of boost power factor correction circuit generally as 100. The AC line 102 is rectified by diodes 104, 106, 108 and 110 to generate a current iac through the inductor 112 when transistor Q1 conducts. When transistor Q1 is off, the voltage at the node joining inductor L1 12 and diode D1 114 will increase, thus providing a higher voltage to the output capacitor Co. The transistor Q1 is operated by an analog average current mode PFC controller 120 and receives a voltage signal through a resistor divider 122, 124. A digital controller may also be utilized to operate the transistor Q1.

The voltage and current for a boost PFC circuit are shown in FIG. 2 generally as 200. The AC voltage is shown as Vac, the inductor current shown as iL and the AC current is shown as iac. The highlighted area 202 shows spikes in the current on the AC line which distorts the input current significantly. Known solutions include the use of a snubber circuit to dissipate the energy or to use complex resonant voltage valley tracking Dissipating energy is not an optimal approach. The resonance voltage valley tracking must track frequencies in the MHz range, which requires a high-speed processor, such as a digital signal processor (DSP), and is thus an expensive solution.

Accordingly, there is a need for a low-cost solution that can reduce the total harmonic distortion (THD) on the input AC line and improve the efficiency of the PFC circuit.

### SUMMARY OF THE INVENTION

It is a general object of the invention to provide a power factor correction circuit.

This and other objects and features of the present invention can be found in accordance with an aspect of the invention by a power factor correction (PFC) circuit comprising an inductor coupled between a DC input voltage and an output. A diode is in series with the inductor and is coupled to an output capacitance. A switching transistor having parasitic capacitance is coupled from a node between the inductor and the diode to a reference potential. A digital controller is coupled to a gate of the switching transistor for generating a control signal to turn on the switching transistor to avoid continuing oscillation between the inductor and the parasitic capacitance of the switching transistor during discontinuous mode operation.

Another aspect of the invention includes a digital controller for a power factor correction (PFC) circuit, comprising first means for generating a first control signal for a switching transistor to avoid continuous oscillation between an inductor and parasitic capacitance of the switching transistor during discontinuous mode operation when an input voltage is less than substantially 50% of an output voltage. A second means generates a second control signal for a switching transistor to avoid continuous oscillation between an inductor and parasitic capacitance of the switching transistor during discontinuous mode operation when an input voltage is greater than substantially 50% of an output voltage.

A third aspect of the invention is provided by a method for power factor correction comprising generating a first control signal for a switching transistor to avoid continuous oscillation between an inductor and parasitic capacitance of the switching transistor during discontinuous mode operation when an input voltage is less than substantially 50% of an output voltage. Also, generating a second control signal for a switching transistor to avoid continuous oscillation between an inductor and parasitic capacitance of the switching transistor during discontinuous mode operation when an input voltage is greater than substantially 50% of an output voltage.

A fourth aspect of the invention includes a digital controller for a power factor correction (PFC) circuit, a digital controller comprising first means for generating a first control signal for a switching transistor to avoid continuous oscillation between an inductor and parasitic capacitance of the switching transistor during discontinuous mode operation when an input voltage is less than substantially 50% of an output voltage, wherein the first means predicts the time between activating the switching transistor as:

Ts₁=TDa+TDb+Tr/4+tx

### Where:

Ts₁, Ts₂=the predicted time to activate the switching transistor
TDa=the ON time of the switching transistor
TDb=the time for the inductor current to return to 0=TDa·Vin/(Vo−Vin)
Vin=input voltage
Vo=output voltage
Tr/4=one fourth of the resonance period
tx=the time between the end of the first quarter of resonance period and the zero voltage switching (ZVS) time, wherein tx can be calculated by:

tx=1/ωr·arc Sin(Vin/Vp)+[Vp/(Vin·ωr)]·√[1−(Vin/Vp)2]

where
Vp=Vo−Vin and ωr is the angular frequency of the resonant circuit.
ωr=1/(2π·Tr)

second means for generating a second control signal for a switching transistor to avoid continuous oscillation between an inductor and parasitic capacitance of the switching transistor during discontinuous mode operation when an input voltage is greater than substantially 50% of an output voltage, wherein the second means predicts the time between activating the switching transistor as:

Ts₂=TDa+TDb+Tr/2

wherein Ts₁ and Ts₂ are determined and, depending on input voltage value, Ts₁ or Ts₂ is used to activate the switching transistor, Ts is limited to Tmin=TDa+TDb.

### BRIEF DESCRIPTION OF DRAWINGS

Further aspects of the invention will appear from the appending claims and from the following detailed description given with reference to the appending drawings:

FIG. 1 is a schematic block diagram of a prior art PFC device having an analog average current mode controller;

FIG. 2 illustrates the waveforms of the circuit shown in FIG. 1;

FIG. 3 shows the equivalent resonant circuit for the circuit shown in FIG. 1;

FIG. 4 shows the waveforms of the circuit of FIG. 1;

FIG. 5 shows prediction of the switching time utilizing the present invention when Vinput is less than one half of Voutput;

FIG. 6 shows curve fitting for calculation of the value of the time tx;

FIG. 7 shows the action of the switching time utilizing the present invention when Vinput is greater than one half of Voutput;

FIG. 8 shows the operation of the PFC device in CCM mode;

FIG. 9 shows the effects of nonlinear parasitic capacitance in the switching transistor;

FIG. 10 shows a power factor correction circuit employing the present invention and shows the optional correction for nonlinear parasitic capacitance;

FIGS. 11a and 11b show a comparison between the prior art of the present invention at low line;

FIG. 12 shows the waveforms of a PFC device utilizing the present invention at 10% load and low line;

FIGS. 13a and 13b show a comparison of the prior art and the present invention at highline with additional delay to tx;

FIG. 14 shows the waveforms at highline and 20% load with valley switching;

FIG. 15 shows a comparison between the prior art the present invention at low line; and

FIG. 16 shows a comparison between the prior art and the present invention at highline.

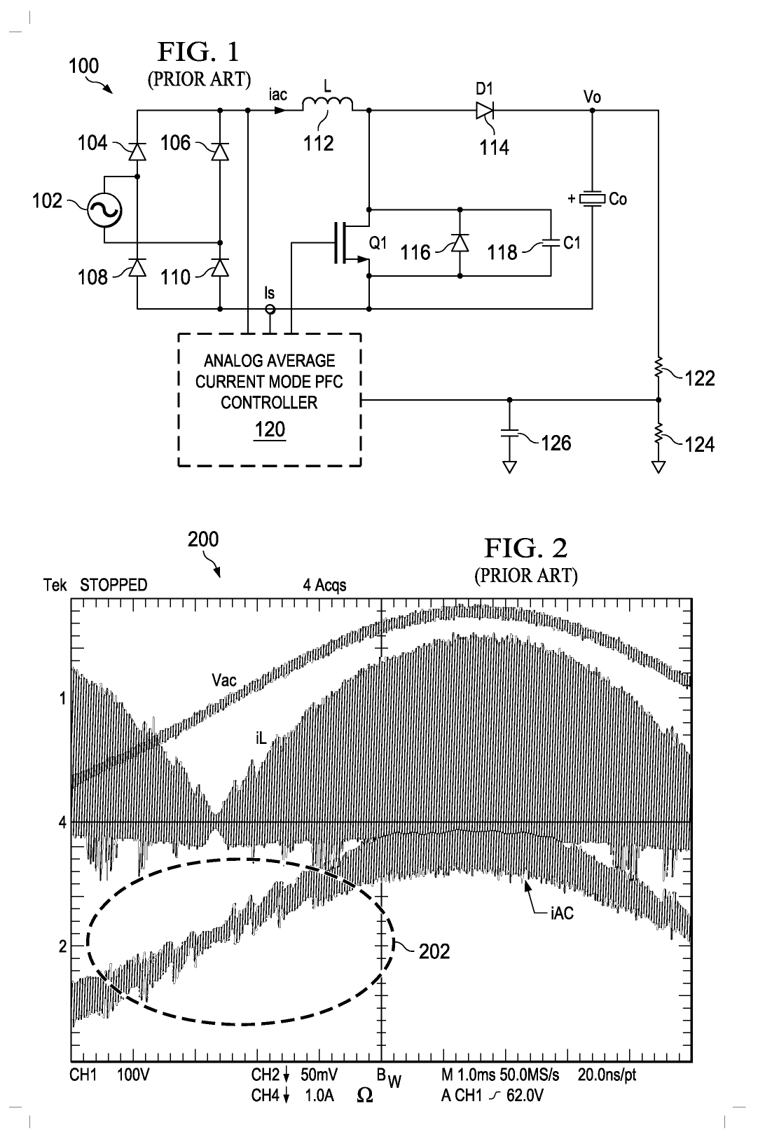

### DETAILED DESCRIPTION OF EXAMPLE EMBODIMENTS

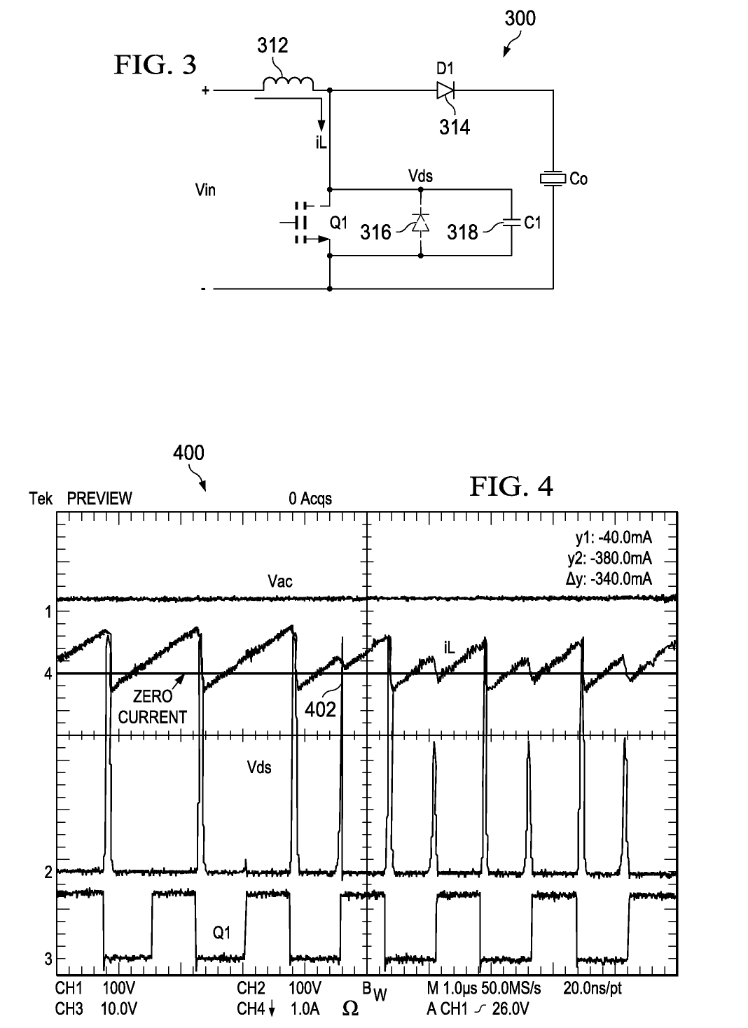

The inventor of the present application has analyzed this problem, which can be best understood in conjunction with the equivalent resonant circuit shown in FIG. 3, generally as 300. Generally, PFC circuits with a power level over 200 W use average—current mode control and operate at a constant switching frequency. The boost inductor current iL can maintain continuous—conduction mode (CCM) for a heavier load range. However, at light loads, the current becomes discontinuous and the PFC circuit enters discontinuous operation mode (DCM). Once the current in the boost inductor 312 declines to zero, the diode 314 will be back biased and the output capacitor CO will not be part of the circuit. The inductor 312 will then resonate with the transistor Q1 parasitic capacitance 318. The resonance current can be large enough to distort the PFC current significantly as shown in area 202 of FIG. 2. Depending on the transistors turn on time, the resonant circuit contributes an average current in a different way during each switching cycle. In other words, the resonance current adds to the switching current in one cycle, and may subtract from the switching current in the next cycle, which causes a large current steps, as shown in area 202 of FIG. 2. This effect occurs at a much higher frequency than the current loop bandwidth of the PFC at discontinuous conduction mode, so the current loop cannot regulate the boost inductor current fast enough to compensate for the abrupt current disturbance. FIG. 4 shows magnified waveforms of the Vds voltage and drive voltage for the transistor Q1 as well as the inductor current iL which shows the disturbances at 402, for example.

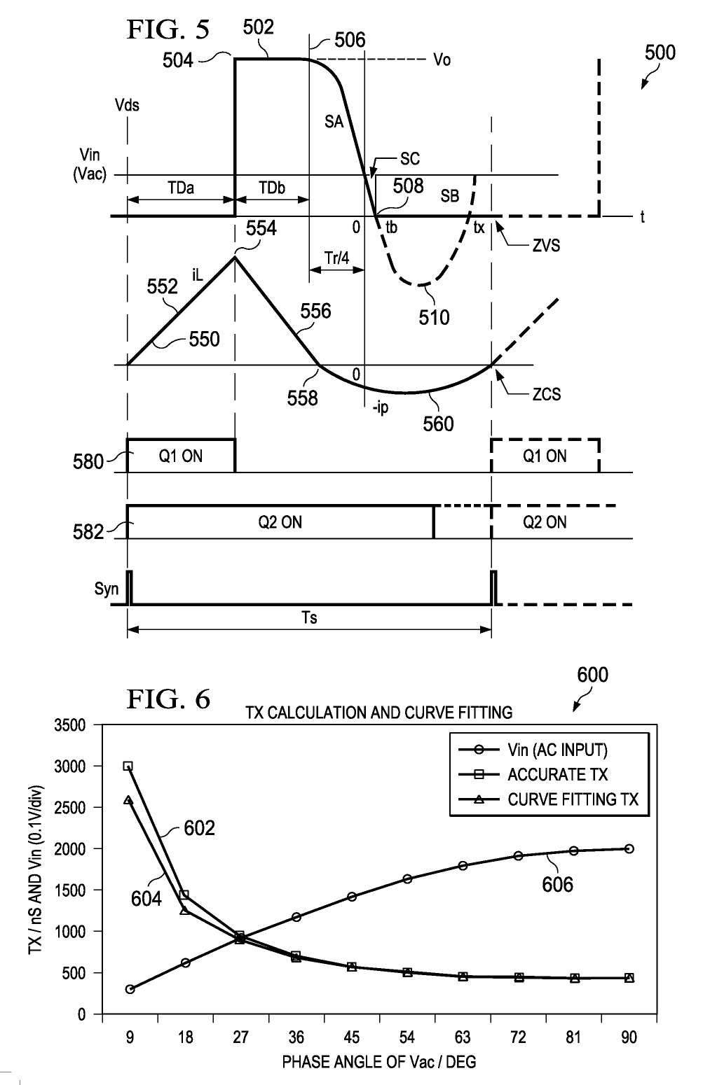

A more detailed investigation for the situation in which the input voltage Vin is less than one half of the output voltage Vo, is shown in FIG. 5 generally as 500. In the DCM mode, after iL decreases to zero, the boost inductor 112, 312 resonates with the capacitance C1 118, 318. If the instantaneous AC voltage is lower than one half of the PFC output voltage, the Vds of transistor Q1 can resonate to 0V and be clamped by the MOSFET body diode 118, 318. If transistor Q1 can be turned on at a position where the current resonates back from negative to zero, the resonant current will not contribute to the switching current and the harmonic distortion caused by this resonation can be eliminated.

FIG. 5 shows the waveforms for the voltage across Q1 as 502 and current through the inductor 112, 312 as 550, of a boost PFC circuit during discontinuous mode operation. If the transistor Q1 is on, as shown at 580, the voltage across the transistor Q1 is essentially zero and current iL rises at 552 during time period TDa. During time period TDb, the transistor Q1 has turned off, the voltage 502 reaches its peak 504 and the current iL reaches its peak 554. During this period the current through the inductor decreases at 556. After time TDb, the voltage across Q1 is at its maximum 506 and the current iL goes to zero, thus entering discontinuous mode. Resonance between the inductor 112, 312 and the parasitic capacitance 118, 318 occurs during the period labeled as Tr/4, which is one quarter of a resonance cycle. The current iL continues to go negative at 558 until the point labeled zero on the X axis at which time the current starts increasing as shown at 560. Once we voltage 502 starts to go negative at 508, at time Tb, the body diode 116, 316 will begin to conduct thus clipping the voltage close to 0 V. The waveform 510 would be present if the body diode were not there. The time tx is the point at which zero voltage switching (ZVS) and zero current switching (ZCS) should occur.

If the PFC circuit is controlled by a digital controller, this time can be precalculated. A suitable digital controller can be a UCD 3XXX, such as a UCD 3020 digital controller manufactured by Texas Instruments Incorporated, for example. For steady-state operation, the Volt •Second for the boost inductor is balanced for each switching cycle. As shown in FIG. 5, the turn-on time for transistor Q1 is TDa. The time, TDb for the boost inductor current iL to return to zero is:

TDb=TDa*Vin/(Vo−Vin) equation 1

during the resonation, when the boost inductor current L resonates back from a negative value to zero at time tx, the Volt •Second balance can be applied to the boost inductor as well. Using Volt •Second balancing:

SA=SB+SC equation 2

tx=(1/ωr)·arc Sin(Vin/Vp)+[Vp/(Vin·ωr)]·√[1−(Vin/Vp)2] equation 3

where Vp=(Vo−Vin) and ωr is the angular frequency of the resonant circuit (½ πTr), and where Tr is the time of resonation.

In order to simplify the calculations of tx, a curve fitting technique was used as shown in FIG. 6. In FIG. 6, 606 shows the AC input voltage, 602 shows the accurate calculated tx and 604 shows the curve fitting tx. Based on the curve fitting shown in FIG. 6, tx can be simplified as:

tx=Vo·Tᵣ/(8·Vin) equation 4

This approximated tx value can be calculated with reduced processor computing time.

From equations (1) and (3) or (4),

Ts=TDa+TDb+Tr/4+tx equation 5

This equation can be utilized to calculate the position of the resonant current which resonates back from the negative to zero. The UCD 3XXX will reset the switching so that the next pulse width modulation cycle will turn on at the position tx. Since Vds is zero at this point ZVS control is achieved.

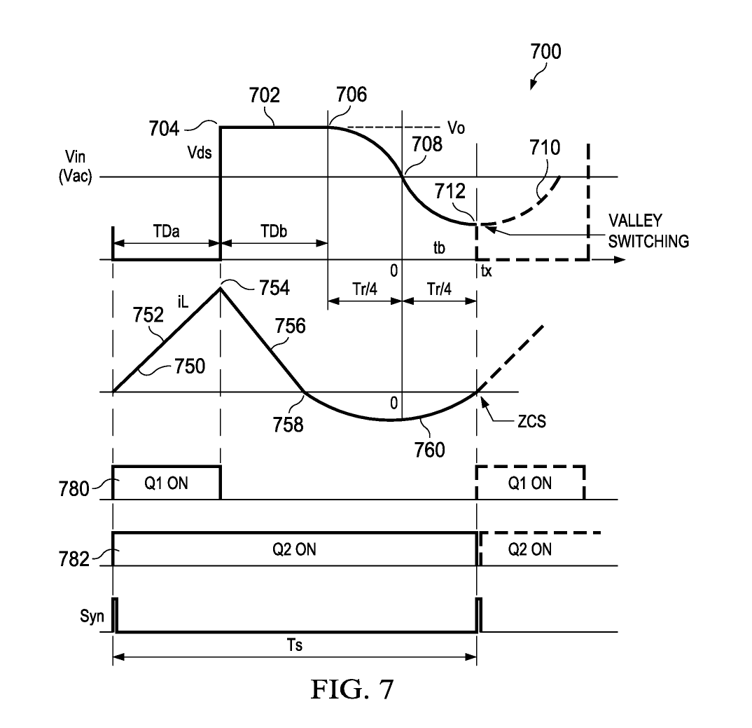

FIG. 7 illustrates the waveforms similar to FIG. 5, for the situation in which the input voltage Vin is greater than one half the boosted output voltage Vo. In this situation the voltage across MOSFET Q1 Vds never resonates to 0 V as shown at 712. FIG. 7 shows the waveforms for the voltage across Q1 as 702 and current through the inductor 112, 312 as 750, of a boost PFC circuit during discontinuous mode operation. If the transistor Q1 is on, as shown in 780, the voltage across the transistor Q1 is essentially zero and current iL rises at 752 during time period TDa. During time period TDb, when the transistor Q1 is turned off, the voltage 702 reaches its peak 704 and the current iL which reaches its peak 754. During this period the current from the inductor decreases at 756. After time TDb, the voltage across Q1 is at its maximum 706 and the current iL goes to zero. Resonance between the inductor 112, 312 and the parasitic capacitance 118, 318 occurs during the two periods, each labeled as Tr/4, which is one quarter of a resonance cycle. The current iL continues to go negative at 758 until the point labeled zero on the X axis at which time the current starts increasing as shown at 760. Once the voltage 702 starts to go negative at 708, at time tb, Q1 is turned on, thus clipping the voltage close to 0 V. The waveform 710 would be present if Q1 is not turned on. If the next pulse width modulation cycle turns on at the position tx, there is no ZVS as the Vds is not zero. However, Vds is at its lowest point, which is called valley switching. Thus, with the current being at zero producing ZCS and the voltage being at its minimum, the valley switching value, the dissipation across MOSFET Q1 is at its minimum.

In this case, tx=Tr/4 equation 6

The predicted switching Ts=TBa+PDb+Tr/4+Tr/4 equation 7

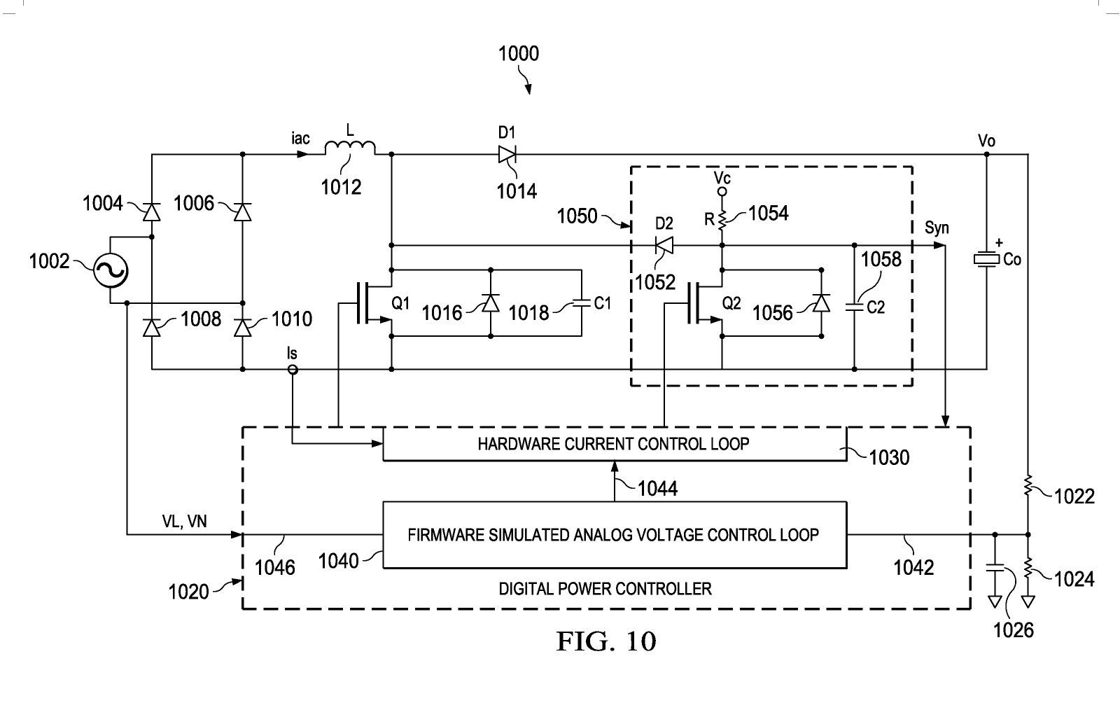

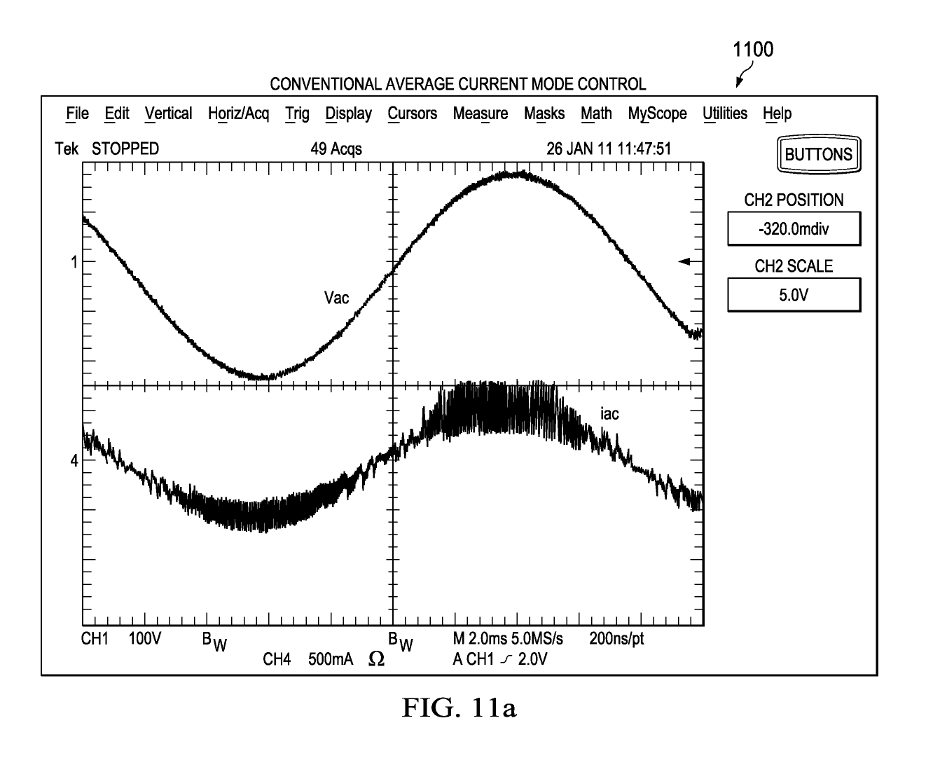

Thus, relatively simple hardware, shown in FIG. 10 can be used to implement this technique. The transistor Q1 is controlled by the controllers average mode current loop. The simple manner in which the predicted switching period Ts can be calculated solves the problem of switching at the point where the input voltage is lower than one half of the output voltage. The predicted switching period Ts is calculated for both the situation in which input voltage is below one half of the output voltage and situation in which the input voltage is greater than one half of the output voltage. Depending on the input voltage value, the corresponding Ts₁ or Ts₂ is then utilized to control transistor Q2.

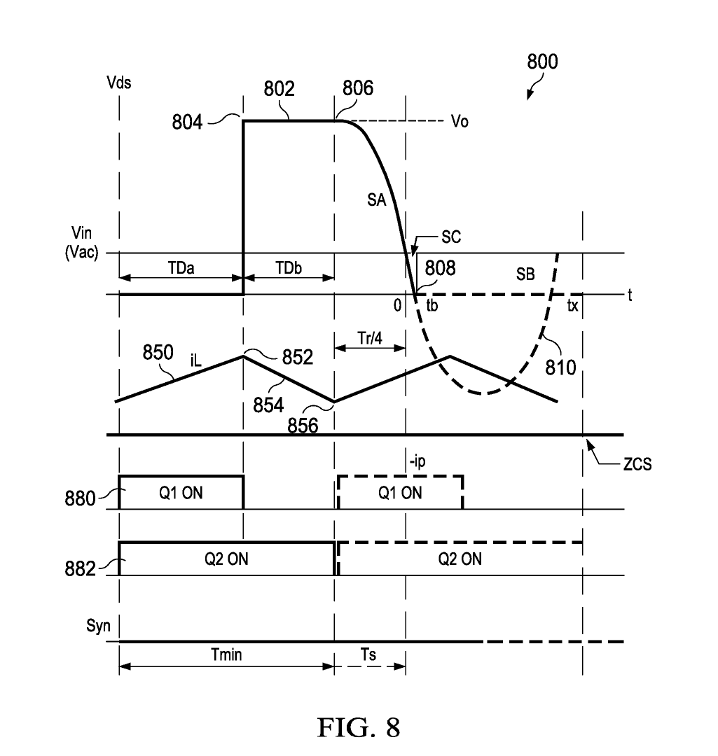

FIG. 8 shows the operation of the circuit in continuous conduction mode (CCM). Here we see that the inductor current iL rises linearly at 851 when transistor Q1 is on at 880 and the voltage across transistor Q1 is essentially zero. The current reaches a peak at 852 and falls at 854 reaching zero current at 856. Because the current does not go below zero, the circuit does not enter discontinuous conduction mode (DCM). The predicted switching time Ts=TDa+TDb+Tr/4 exceeds the minimum time Tmin which equals TDa plus TDb. The shorter switching time Tmin is utilized. The calculations necessary under discontinuous conduction mode (DCM) can thus be discontinued.

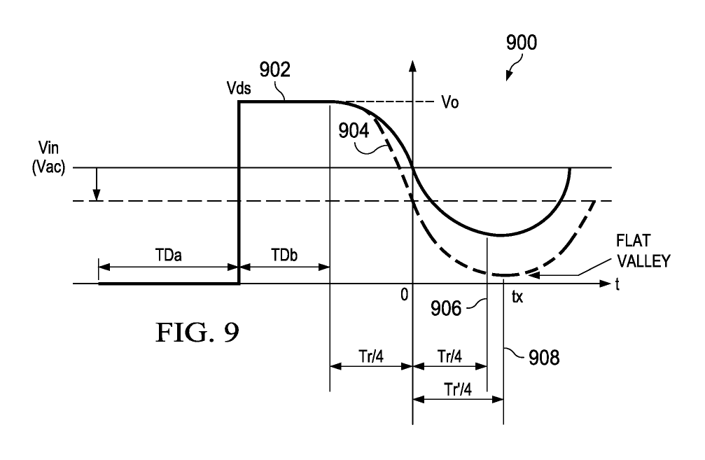

Up until this point, the parasitic capacitance C1 118, 318 has been assumed to be constant. However, the parasitic capacitance of the transistor is actually nonlinear with respect to its drain to source voltage Vds. The output capacitance of a typical transistor Q1, such as a SPP20N60C3, for example, maintains a relatively constant capacitance from 600 V down to 50 V, but the value increases by about 10 times at Vds=25 volts, to nearly one hundred times at Vds=0 volts. This nonlinearity introduces errors into the calculations when the instantaneous AC voltage is lower than about one half of the output voltage. The effect of the variable capacitance is shown in FIG. 9 generally as 900. When the Vds valley voltage is lower than approximately 50 V, the nonlinear characteristics of the output capacitance of transistor Q1 starts to affect the Vds waveform 902, as shown in the dashed line 904. Thus, the actual valley occurs later than the calculated position, at 908 instead of 906 as can be seen from FIG. 9, the valley flattens out allowing the switching loss increase was caused by the premature turning on of the transistor Q1 to be considered insignificant. This effect can be corrected by the optional circuit 1050 shown in FIG. 10.

FIG. 10 shows the circuit of a PFC device generally as 1000. The AC voltage 1002 is rectified by diodes 1004, 1006, 1008, 1010 and the rectified current passes through inductor 1012 and then to ground through transistor Q1. Transistor Q1 has a body diode 1016 and the parasitic capacitance C1 1018. The transistor Q1 is controlled by a digital power controller 1020 which receives the inputs of the current iₛ and the voltages VL (line voltage) and VN (neutral voltage).

A diode D1 1014 is connected to the node between inductor 1012 and transistor Q1. The diode is connected to output capacitor Co. The voltage across Co is measured by resisters 1022, 1024 and input into digital power controller 1020. The digital controller 1020 can be a UCD 3XXX, such as a UCD 3020 digital controller manufactured by Texas Instruments Incorporated, for example. Other controllers capable of performing the calculations discussed above can also be utilized. The controller 1020 comprises a hardware current control loop 1030 and a firmware simulated analog voltage control loop 1040. The analog function 1040 mimics the function of an analog controller, such as analog controller UCC 3818 manufactured by Texas Instruments Incorporated, for example, in firmware. The hardware current control loop 1030 utilizes only one of the four hardware channels of a UCD 3020 digital controller. The analog voltage control loop 1040 receives the voltage is VL and VN on line 1046 and receives a measure of the output voltage on line 1042. An output of the analog voltage control loop on line 1044 provides a signal to the hardware control 1030. The calculations discussed above are performed in the firmware to provide a signal to the hardware to control the transistor Q1.

FIG. 10 contains the optional circuit 1050, to compensate for the nonlinear parasitic capacitance of transistor Q1. The circuit consists of a diode 1052 having its anode connected to the junction of transistor Q1 and inductor 1012 and its cathode connected to a resistor 1054 connected to a voltage source Vc and the drain of a second transistor Q2, the source of which is connected to ground. A capacitor 1058 is connected between the node and ground. Transistor Q2 has a body diode 1056. The circuit generates the signal Syn which is fed into controller 1020. Referring to FIG. 5, the signal Syn causes a new PWM switching cycle and transistor Q1 to be turned on at 580. Transistor Q2 is also turned on at the same time at 582. Transistor Q2 remains on during the time Ts. After the expiration of Ts, with transistor Q2 off, when the voltage across transistor Q1 begins to rise, it will back bias diode 1050, which will generate the signal Syn. This signal is input into the hardware current control loop 1030 and causes the generation of the signal 580 to turn transistor Q1 on immediately. The circuit 1050 detects the rise of the voltage across transistor Q1 to 3 V, for example, thus signaling the time to generate a new switching period TDa. Thus, the circuit corrects for the variation in turn on time for transistor Q1 as a result of the effects of the nonlinear parasitic capacitance of transistor Q1. Transistor Q2 is used to block the Syn signal completely when the circuit operates in continuous conduction mode (CCM).

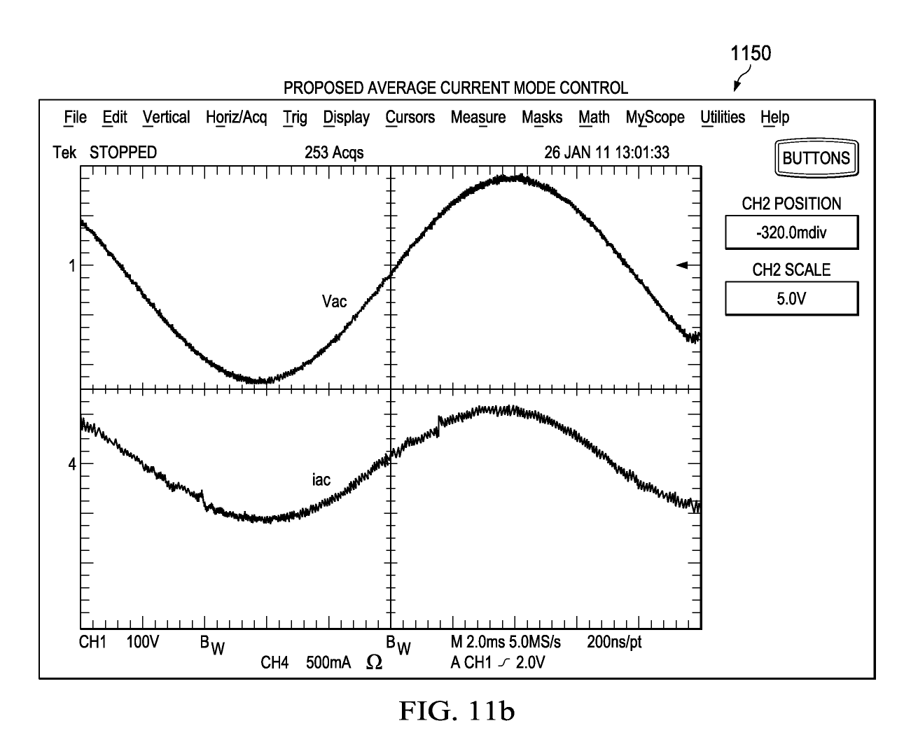

FIG. 11 shows a comparison between a prior art circuit in the circuit employing the present invention. FIG. 11a shows the waveforms of a conventional average current mode control PFC circuit, generally as 1100, having a total harmonic distortion (THD) of 5.25% and a power factor of 0.99. FIG. 11b shows the waveforms of the present invention, generally as 1150, having a THD of 4.18% and a power factor of 0.99. It should be noted that since the standard THD is measured only up to the 30th harmonic, the THD reduction does not appear as significant as it is. The result can be seen by comparing the waveforms for iac between FIGS. 11a and 11b.

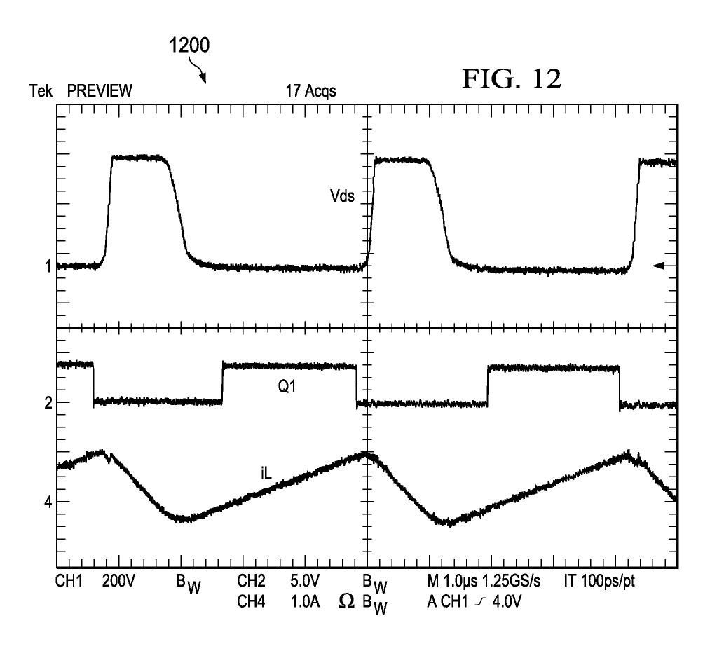

FIG. 12 shows the waveforms, generally at 1200, of a PFC device having harmonic reduction and ZVS, ZCS operation at low line and 10% load.

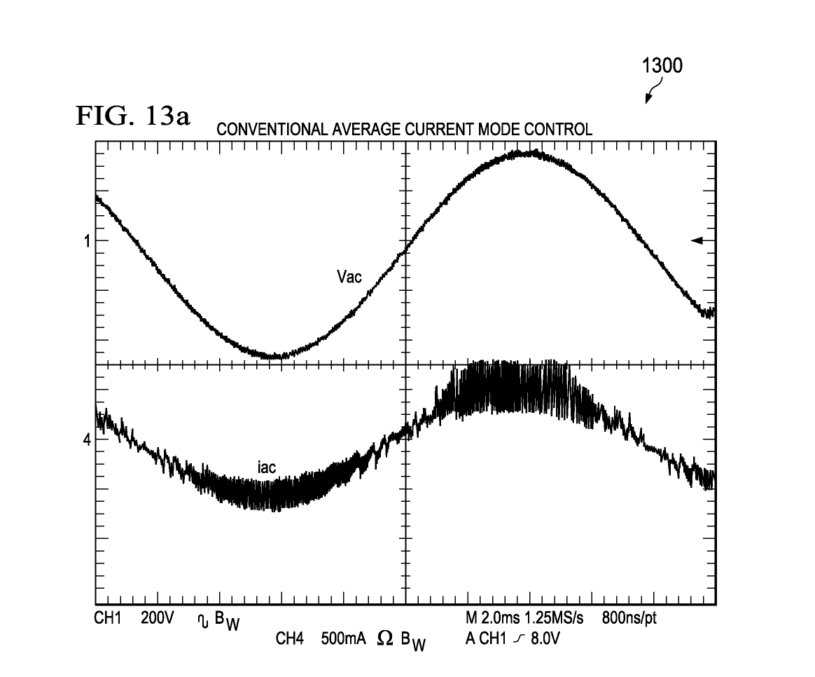

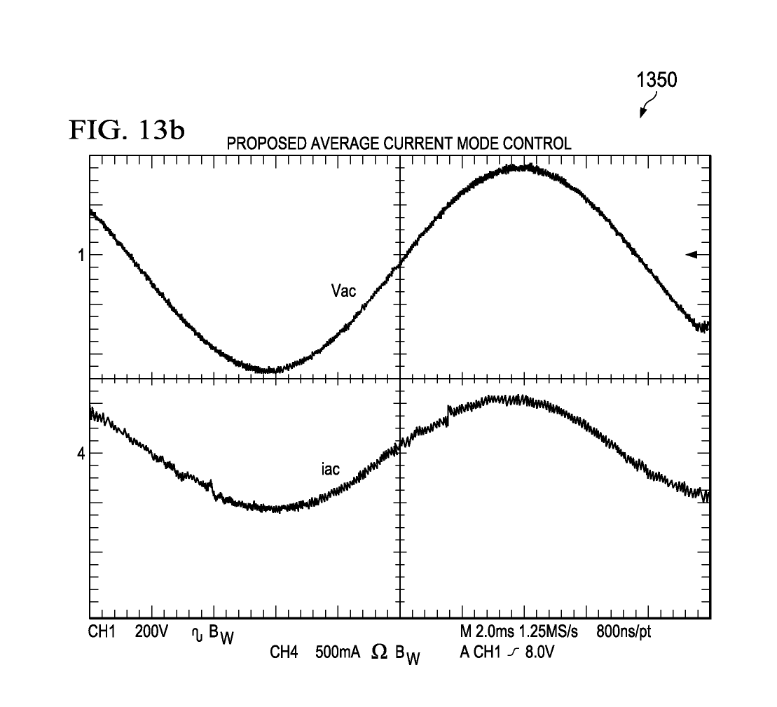

FIG. 13 shows a high line performance of a PFC circuit having an additional delay to tx. FIG. 13a shows the waveforms of a conventional average mode control circuit generally as 1300. FIG. 13b shows the waveforms of the present invention generally as 1350. The conventional circuit illustrated in FIG. 13a has a conventional average current control mode, a THD of 4.34% and a power factor of 0.96. The present invention illustrated in FIG. 13b has a THD of 4.18% power factor 0.97. Again, a comparison of FIGS. 13a and 13b show a much greater improvement than the THD numbers would suggest. The circuits were operated at 20% load.

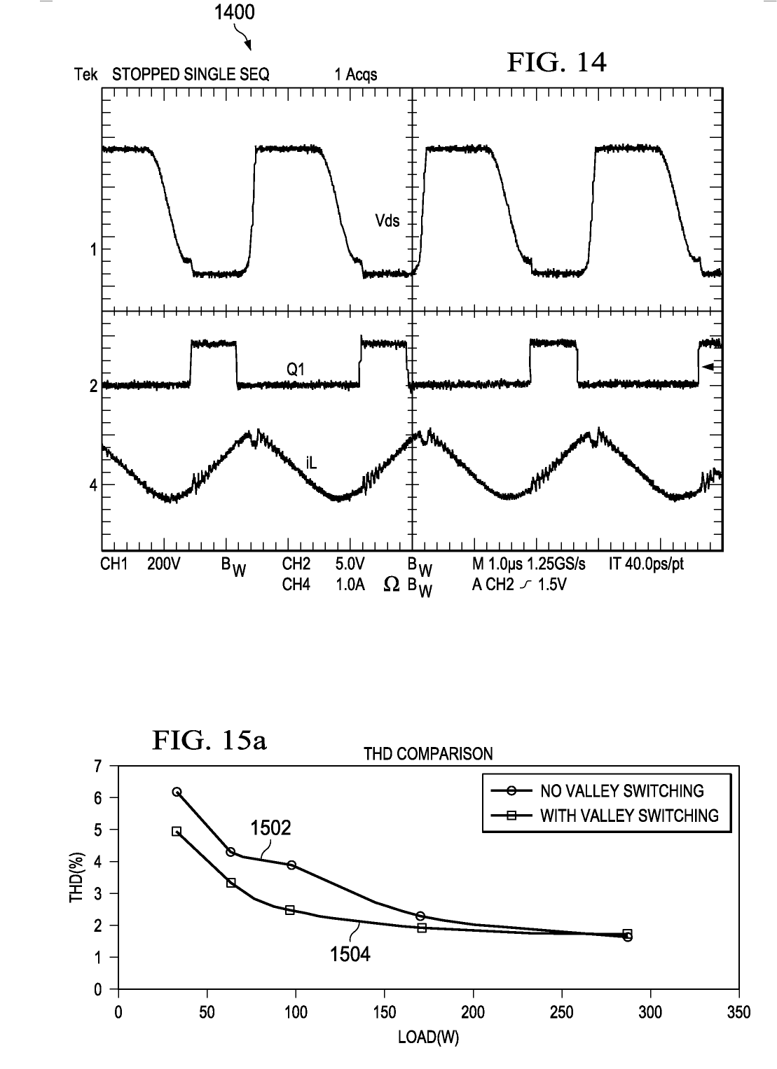

FIG. 14 illustrates the waveforms for the present invention having valley switching, operated at high line and 20% load.

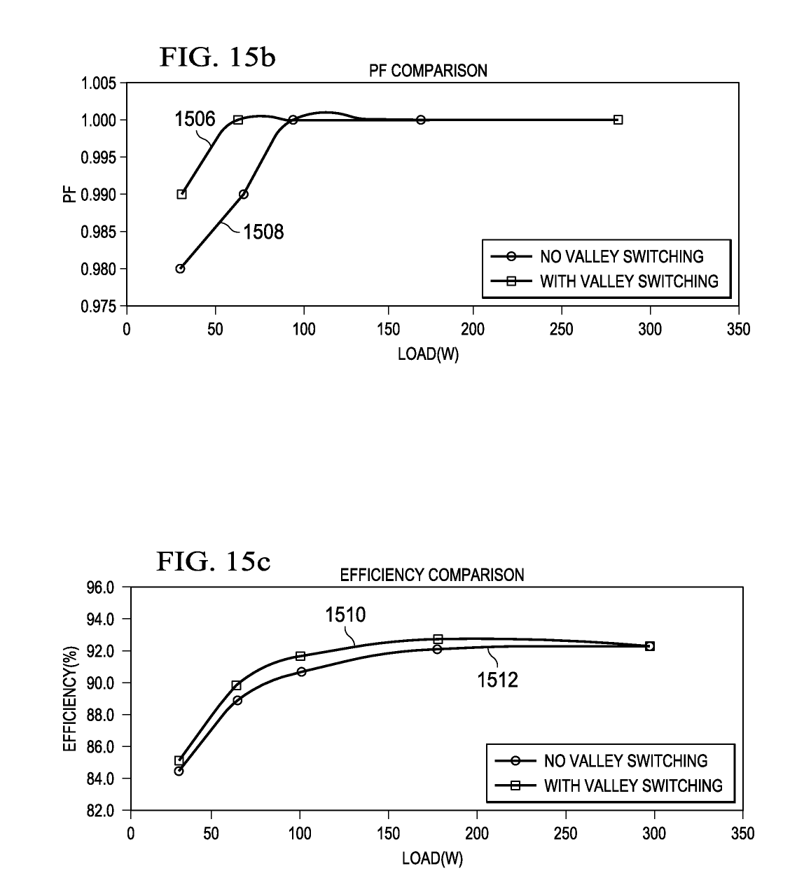

FIGS. 15a through 15c illustrate comparisons between the prior art in the present invention. FIG. 15a shows a comparison of the THD. The upper waveform 1502 is the prior art with no valley switching, whereas the waveform 1504 shows the present invention with valley switching. A significant decrease in the THD can be seen by comparing waveform 1504 against waveform 1502.

FIG. 15b shows a comparison of the power factor correction. Waveform 1508 shows the prior art with no valley switching whereas waveform 1506 shows the present invention with valley switching. A significant difference in the power factor correction can be seen at loads less than about 100 Watts.

FIG. 15c shows a comparison between the prior art and the present invention at low line. Waveform 1512 shows the prior art without valley switching whereas the present invention is shown by waveform 1510 with valley switching. As can be seen, the efficiency is higher than the present invention until the load approaches 300 W.

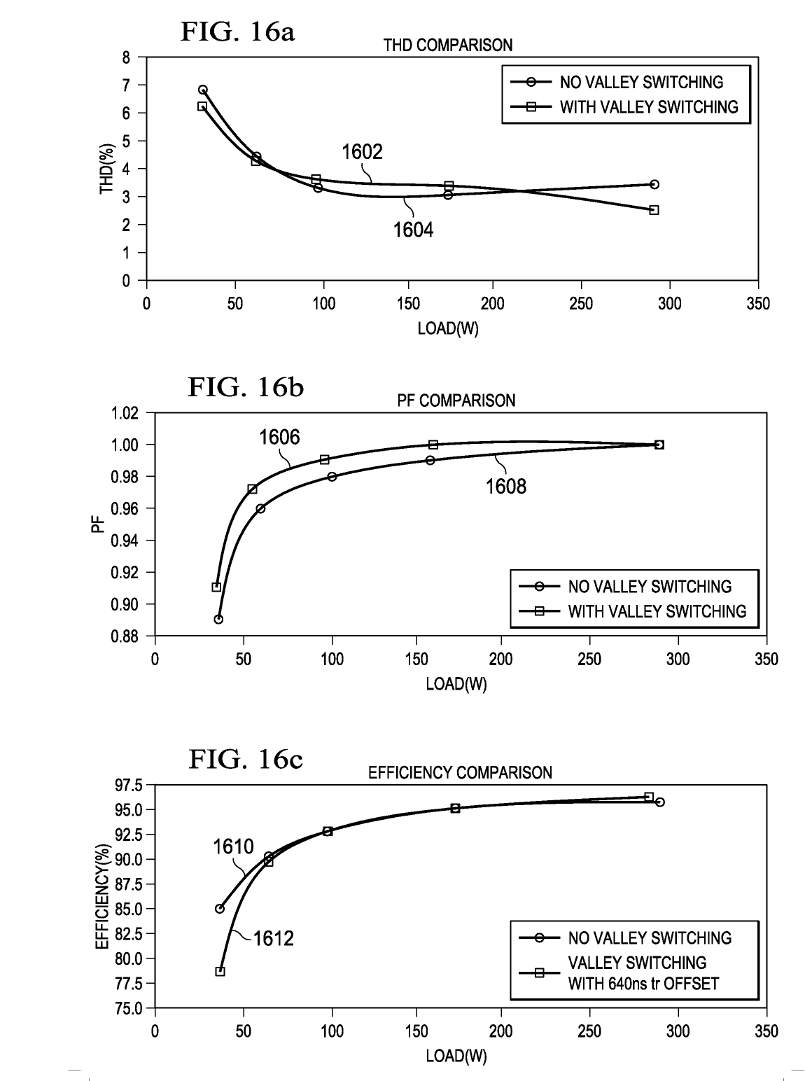

FIGS. 16a through 16c show a comparison of the prior art and the present invention at highline. FIG. 16 a shows a THD comparison. Waveform 1602 shows the prior art with no valley switching whereas waveform 1604 shows the present invention. It can be seen that most loads, the THD is lower with the present invention.

FIG. 16b shows a comparison of the power factor correction. Waveform 1608 shows a prior art with no valley switching whereas the present invention is shown in waveform 1606 with valley switching. The power factor correction is improved with the present invention until the lower reaches almost 300 W.

FIG. 16(c) shows efficiency comparison between the prior art with no valley switching and present invention with valley switching and an additional 640 ns offset.

Although the invention has been described in detail, it should be understood that various changes, substitutions and alterations can be made thereto without departing from the spirit and scope of the invention as defined by the appended claims.

1. A power factor correction (PFC) circuit comprising:
an inductor coupled between a DC input voltage and an output;
a diode in series with the inductor and coupled to an output capacitance;
a switching transistor having parasitic capacitance coupled from a node between the inductor and the diode to a reference potential;
a digital controller coupled to a gate of the switching transistor for generating a control signal to turn on the switching transistor to avoid continuing oscillation between the inductor and the parasitic capacitance of the switching transistor during discontinuous mode operation.

2. The PFC circuit of claim 1, wherein when the DC input voltage is less than substantially one half of the output voltage, the time between activating the switching transistor is predicted as:
TS₁=T Da+TDb+Tr/4+tx
Where:
Ts₁=the predicted time to activate the switching transistor
TDa=the ON time of the switching transistor
TDb=the time for the inductor current to return to 0
Tr/4=one fourth of the resonance period
tx=the time between the end of the first quarter of resonance period and the zero voltage switching (ZVS) time

3. The PFC circuit of claim 2, wherein the time
TDb=TDa·Vin/(Vo−Vin)
Where
Vin=input voltage
Vo=output voltage

4. The PFC circuit of claim 1, wherein tx can be calculated by:
tx=(1/ωr)·arc Sin(Vin/Vp)+[Vp/(Vin·ωr)]·√[1−(Vin/Vp)2]
where
Vp=Vo−Vin and ωr is the angular frequency of the resonant circuit. ωr=1/(2πr·Tr)

5. The PFC circuit of claim 3, wherein tx can be calculated by:
tx=(1/ωr)·arc Sin(Vin/Vp)+[Vp/(Vin·ωr)]·\sqrt{[1−(Vin/Vp)2]}
where
Vp=Vo−Vin and ωr is the angular frequency of the resonant circuit
ωr=1/(2πr·Tr)

6. The PFC circuit of claim 5, wherein tx can be approximated by:
tx=Vo·Tr/(8·Vin)

7. The PFC circuit of claim 1, wherein when the DC input voltage is greater than substantially one half of the output voltage, the time between activating the switching transistor is predicted as:
Ts₂=TDa+TDb+Tr/2
Where
Ts₂=the predicted time to activate the switching transistor
TDa=the ON time of the switching transistor
TDb=the time for the inductor current to return to 0
Tr=the resonance period

8. The PFC circuit of claim 5, wherein when the DC input voltage is greater than substantially one half of the output voltage, the time between activating the switching transistor is predicted as:
Ts₂=TDa+TDb+Tr/2
Where
TDa=the ON time of the switching transistor
TDb=the time for the inductor current to return to 0
Tr=the resonance period

9. The PFC of claim 7, wherein Ts₁ and Ts₂ are determined and is used to activate the switching transistor for corresponding input voltage ranges respectively.

10. The PFC circuit of claim 1, wherein during continuous conduction mode, Ts is limited to Tmin=TDa+TDb.

11. In a power factor correction (PFC) circuit, a digital controller comprising:
first means for generating a first control signal for a switching transistor to avoid continuous oscillation between an inductor and parasitic capacitance of the switching transistor during discontinuous mode operation when an input voltage is less than substantially 50% of an output voltage; and
second means for generating a second control signal for a switching transistor to avoid continuous oscillation between an inductor and parasitic capacitance of the switching transistor during discontinuous mode operation when an input voltage is greater than substantially 50% of an output voltage.

12. The digital controller of claim 11, wherein the first means predicts the time between activating the switching transistor as:
Ts₁=TDa+TDb+Tr/4+tx
Where:
Ts₁=the predicted time to activate the switching transistor
TDa=the ON time of the switching transistor
TDb=the time for the inductor current to return to 0
Tr/4=one fourth of the resonance period
tx=the time between the end of the first quarter of resonance period and the zero voltage switching (ZVS) time

13. The digital controller of claim 12, wherein the time TDb=TDa·Vin/(Vo−Vin)
Where
Vin=input voltage
Vo=output voltage

14. The digital controller of claim 13, wherein tx can be calculated by:
tx=1/ωr·arc Sin(Vin/Vp)+[Vp/(Vin·ωr)]·√[1−(Vin/Vp)2]
where
Vp=Vo−Vin and ωr is the angular frequency of the resonant circuit.
ωr=1/(2πr·Tr)

15. The digital controller of claim 14, wherein tx can be approximated by:
tx=Vo·Tr/(8·Vin)

16. The digital controller of claim 12, wherein the second means predicts the time between activating the switching transistor as:
Ts₂=TDa+TDb+Tr/2
Where
Ts₂=the predicted time to activate the switching transistor
TDa=the ON time of the switching transistor
TDb=the time for the inductor current to return to 0=TDa·Vin/Vo−Vin
Tr=the resonance period

17. The digital controller of claim 16, wherein Ts₁ and Ts₂ are determined and is used to activate the switching transistor in the corresponding input voltage ranges respectively.

18. The digital controller of claim 17, wherein during continuous conduction mode, Ts is limited to Tmin=TDa+TDb.

19. A method for power factor correction comprising:
generating a first control signal for a switching transistor to avoid continuous oscillation between an inductor and parasitic capacitance of the switching transistor during discontinuous mode operation when an input voltage is less than substantially 50% of an output voltage; and
generating a second control signal for a switching transistor to avoid continuous oscillation between an inductor and parasitic capacitance of the switching transistor during discontinuous mode operation when an input voltage is greater than substantially 50% of an output voltage.

20. The method of claim 19, wherein the first control signal is predicted as:
Ts₁=TDa+TDb+Tr/4+tx
Where:
Ts=the predicted time to activate the switching transistor
TDa=the ON time of the switching transistor
TDb=the time for the inductor current to return to 0=TDa·Vin/Vo−Vin
Tr/4=one fourth of the resonance period
tx=the time between the end of the first quarter of the resonance period and the zero voltage switching (ZVS) time
Vin=input voltage
Vo=output voltage.

21. In a power factor correction (PFC) circuit, a digital controller comprising:
first means for generating a first control signal for a switching transistor to avoid continuous oscillation between an inductor and parasitic capacitance of the switching transistor during discontinuous mode operation when an input voltage is less than substantially 50% of an output voltage, wherein the first means predicts the time between activating the switching transistor as:
Ts₁=TDa+TDb+Tr/4+tx
Where:
Ts₂=the predicted time to activate the switching transistor
TDa=the ON time of the switching transistor
TDb=the time for the inductor current to return to 0=TDa Vin/(Vo−Vin)
Vin=input voltage
Vo=output voltage
Tr/4=one fourth of the resonance period
tx=the time between the end of the resonance period and the zero voltage switching (ZVS) time, wherein tx can be calculated by:
tx=1/ωr·arc Sin(Vin/Vp)+[Vp/(Vin·ωr)]·√[1−(Vin/Vp)2]
where
Vp=Vo−Vin and ωr is the angular frequency of the resonant circuit.
ωr=1/(2π·Tr)
second means for generating a second control signal for a switching transistor to avoid continuous oscillation between an inductor and parasitic capacitance of the switching transistor during discontinuous mode operation when an input voltage is greater than substantially 50% of an output voltage, wherein the second means predicts the time between activating the switching transistor as:
Ts₂=TDa+TDb+Tr/2
wherein Ts₁ and Ts₂ are determined and a smaller value is used to activate the switching transistor and, wherein during continuous conduction mode, Ts is limited to Tmin=TDa+TDb.

22. The digital controller of claim 11, further comprising a circuit coupled to the first means for generating a signal correcting a nonlinearity in parasitic capacitance of the switching transistor.
